(19) United States
(12) Patent Application Publication
(10) Pub. No.: US 2017/0169155 A1
(43) Pub. Date: Jun. 15, 2017

(54) METHOD TO ADJUST ALLEY GAP BETWEEN LARGE BLOCKS FOR FLOORPLAN OPTIMIZATION

(71) Applicant: GlobalFoundries, Inc., George Town (KY)

(72) Inventors: Michael D. AMUNDSON, Oronoco, MN (US); Timothy D. HELVEY, Rochester, MN (US); Zelun TIE, Rochester, MN (US)

(21) Appl. No.: 14/964,813

(22) Filed: Dec. 10, 2015

(51) Int. Cl. G06F 17/50

(52) U.S. Cl. CPC G06F 17/5072

(57) ABSTRACT

Method, computer program product, and system for reserving space for standard cells in a circuit layout. A matrix is formed from a pool of standard cells that connect to ports along an edge of a circuit block. The matrix is formed of columns of standard cells, wherein the columns have a length equal to or less than a length of the edge. The number of standard cells that fit in a column depends on dimensions of the standard cells in the direction of the column. The cumulative width of the matrix is equal to the number of columns sufficient to include all of the standard cells in the pool multiplied by the dimension of the standard cells in a direction orthogonal to the direction of the column. The circuit block is placed in the circuit layout such that an area defined by the matrix is reserved for the standard cells.

### BACKGROUND

Creating a layout for an electrical circuit is typically an iterative process. The circuit layout may include a number of circuit blocks, such as memory blocks or other pre-arranged circuit section. A number of standard cells or gates, such as AND gates and OR gates, that connect to ports of the circuit blocks, can be arranged on the circuit layout in the areas between and/or around the circuit blocks. Other types of small gates, such as manufacture fillers or DeCap filler cells, may also be arranged on the circuit between the circuit blocks. All of the above-described cells and gates are hereinafter referred to as standard cells. Typically, a circuit designer (e.g., a circuit design engineer and/or circuit design software) places the larger circuit blocks in the circuit layout first and then places the smaller standard cells therebetween. For example, a circuit design engineer may manually place the circuit blocks and the standard cells are placed by circuit design software (e.g., computer aided design (CAD) software). In some circumstances, if two adjacent circuit blocks are placed too close together such that the standard cells for the circuit blocks cannot fit in the area therebetween and/or if there is insufficient space for routings for the standard cells to ports of the circuit blocks, the circuit designer has to move one of the adjacent circuit blocks further away from the other circuit block to make more space. Moving a circuit block may require other circuit blocks to be moved. Designing a circuit layout could require several iterative moves of the circuit blocks to arrive at a final layout design. Such iterative design can be costly and time consuming.

### SUMMARY

According to one embodiment of the present invention, a computer-implemented method for planning a layout of an electrical circuit is provided. The method includes receiving a first circuit block dimension in a first direction of a first side of a first circuit block. The first circuit block includes a first plurality of ports arranged along the first side. The method also includes receiving first dimensions in the first direction and in a second direction for a first plurality of standard cells for connection to the first plurality of ports. The second direction is orthogonal to the first direction. The method also includes calculating a first number of the first plurality of standard cells that can be arranged in a column along the first direction and having a length equal to or less than the first circuit block dimension based on the first dimensions of the first plurality of standard cells in the first direction. The method also includes calculating a first number of columns to include all of the first plurality of standard cells in columns based on the first number of the standard cells that can be arranged in each column. The method also includes calculating a first cumulative width of the first number of columns based on the first dimensions of the first plurality of standard cells in the second direction. The method also includes reserving an area adjacent to the first side of the first circuit block in an electrical circuit layout having a dimension in the first direction equal to the first circuit block dimension and having a dimension in the second direction equal to the calculated first cumulative width.

According to one embodiment of the present invention, a computer program product for planning a layout of an electrical circuit is provided. The computer program product includes a computer-readable storage medium having computer-readable program code embodied therewith. The computer-readable program code is executable by one or more computer processors to receive a first circuit block dimension in a first direction of a first side of a first circuit block. The first circuit block includes a first plurality of ports arranged along the first side. The computer-readable program code is also executable to receive first dimensions in the first direction and in a second direction for a first plurality of standard cells for connection to the first plurality of ports. The second direction is orthogonal to the first direction. The computer-readable program code is also executable to calculate a first number of the first plurality of standard cells that can be arranged in a column along the first direction and having a length equal to the first circuit block dimension, based on the first dimensions of the first plurality of standard cells in the first direction. The computer-readable program code is also executable to calculate a first number of columns to include all of the first plurality of standard cells in columns. The computer-readable program code is also executable to calculate a first cumulative width of the first number of columns based on the first dimensions of the first plurality of standard cells in the second direction. The computer-readable program code is also executable to reserve an area adjacent to the first side of the first circuit block in an electrical circuit layout having a dimension in the first direction equal to the first circuit block dimension and having a dimension in the second direction equal to the calculated first cumulative width.

According to one embodiment of the present invention, a system for planning a layout of an electrical circuit includes a computer processor. The system also includes a computer memory containing a program that, when executed on the computer processor, performs an operation for processing data. The operation includes receiving a first circuit block dimension in a first direction of a first side of the first circuit block. The first circuit block includes a first plurality of ports arranged along the first side. The operation also includes receiving first dimensions in the first direction and in a second direction for a first plurality of standard cells for connection to the first plurality of ports. The second direction is orthogonal to the first direction. The operation also includes calculating a first number of the first plurality of standard cells that can be arranged in a column along the first direction and having a length equal to the first circuit block dimension, based on the first dimensions of the first plurality of standard cells in the first direction. The operation also includes calculating a first number of columns to include all of the first plurality of standard cells in columns. The operation also includes calculating a first cumulative width of the first number of columns based on the first dimensions of the first plurality of standard cells in the second direction. The operation also includes reserving an area adjacent to the first side of the first circuit block in an electrical circuit layout having a dimension in the first direction equal to the first circuit block dimension and having a dimension in the second direction equal to the calculated first cumulative width.

### BRIEF DESCRIPTION OF THE SEVERAL VIEWS OF THE DRAWINGS

FIG. 1A is a schematic diagram of circuit blocks arranged on a substrate in an electrical circuit layout;

FIG. 1B is a schematic diagram of two circuit blocks with standard cells associated with ports of the circuit blocks arranged between the circuit blocks;

FIG. 2A illustrates a process of building a matrix of standard cells from a pool of standard cells associated with an edge of a circuit block according to one embodiment;

FIG. 2B illustrates an area calculation for the completed matrix of standard cells from the process of FIG. 2A;

FIG. 3 illustrates two circuit blocks that are spaced apart by a distance equal to cumulative widths of the areas defined by respective matrices of the standard cells associated with facing edges of the circuit blocks;

FIG. 4 illustrates two standard cells having different dimensions in a first direction and in a second direction from each other;

FIG. 5 is an exemplary curve of a distribution of dimensions in a direction for a pool of standard cells, wherein the curve indicates an average dimension and standard deviations of the dimension;

FIG. 6 illustrates dimensions of an exemplary standard cell before and after a utilization factor has been applied;

FIG. 7 is a block diagram of a system for calculating the matrices and areas along edges of circuit blocks to be reserved for placement of standard cells;

FIG. 8A is a flow chart for a process for calculating the size of a first area along a first edge of a first circuit block to be reserved for placement of standard cells;

FIG. 8B is a flow chart for a process for calculating the size of a second area along a second edge of a second circuit block to be reserved for placement of standard cells, wherein the second edge and the first edge of FIG. 8A face each other, and wherein the process of FIG. 8B includes placing the second circuit block so that the first and second areas are reserved;

FIG. 9A illustrates portions of two circuit blocks in which ports and standard cells are clustered in regions along facing edges of the circuit blocks and in which the clustered regions of the circuit blocks are at least partially aligned;

FIG. 9B illustrates the two circuit blocks of FIG. 9A in which the facing edges are placed a distance apart that is equal to the largest cumulative width of the aligned areas reserved for placement of standard cells;

FIG. 10A illustrates portions of two circuit blocks in which ports and standard cells are clustered in regions along facing edges of the circuit blocks and in which the clustered regions of the circuit blocks are not aligned; and

FIG. 10B illustrates the two circuit blocks of FIG. 10A in which the facing edges are placed a distance apart that is equal to the largest width of one of the areas reserved for placement of standard cells.

### DETAILED DESCRIPTION

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In embodiments described herein, a function or macro (hereinafter referred to as a macro) operating in computer-aided design (CAD) software used to generate an electrical circuit layouts estimates a distance from an edge of a circuit block that needs to be reserved to ensure sufficient but not excessive space to accommodate standard cells interacting with ports of the circuit block on the edge. The estimate is based on the number of standard cells to be placed and the dimensions of the standard cells. In various embodiments, the estimate is also based on a utilization factor that accounts for spacing that will eventually be used to accommodate routing traces between the circuit blocks and the standard cells and other features. To estimate the distance from the edge of the circuit block to reserve for the standard cells, the macro performs a first calculation to determine how many of the standard cells can be stacked in a column along the edge. The first calculation is based on a dimension of the standard cells in the direction along the edge. Additionally, the macro calculates a number of columns needed for the standard cells based on the calculated number of standard cells that can be stacked in a single column and the total number of standard cells to be connected to ports along the edge of the circuit block. Finally, the macro calculates a distance from the edge of the circuit block to reserve for the standard cells by multiplying the number of columns needed by a dimension of the standard cells in a direction orthogonal to the edge of the circuit block.

Distances from all edges of the various circuit blocks can be determined, according to the method outlined above and described in more detail below, and the circuit blocks can be placed on a circuit layout and spaced apart from each other such that the calculated distances are preserved. Thereafter, a circuit designer (e.g., a circuit design engineer and/or circuit design software) can place the standard cells and the routing for the standard cells in the reserves areas between the circuit blocks defined by the distance calculated above. By spacing the circuit blocks apart according to the method outlined above, the likelihood of the circuit blocks having to be moved later to accommodate placement of the standard cells is reduced.

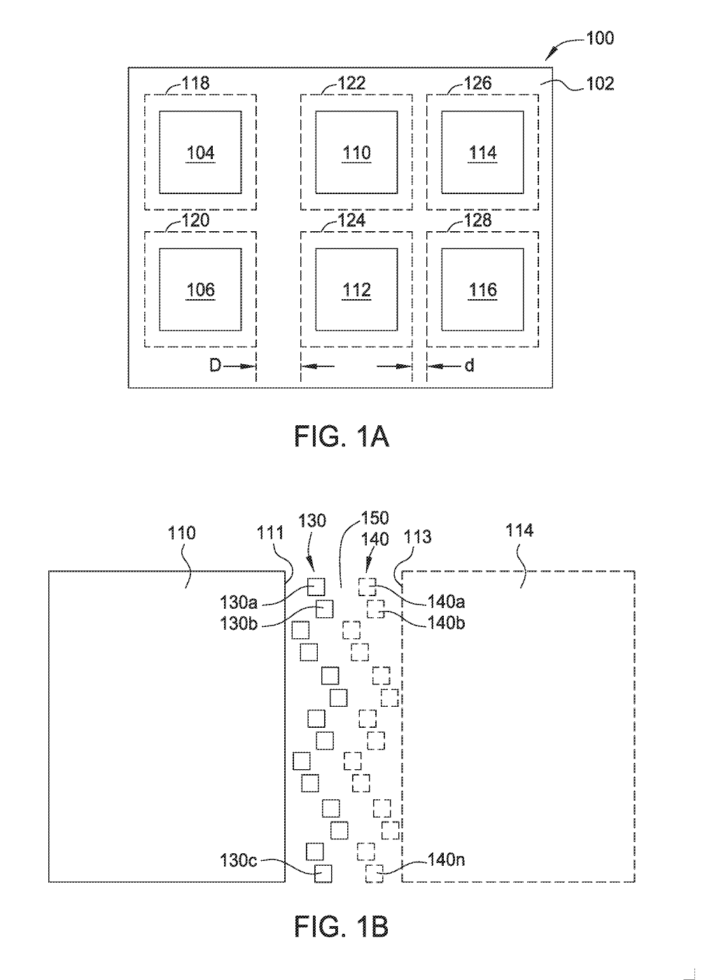

FIG. 1A illustrates a circuit layout 100 with six circuit blocks 104, 106, 110, 112, 114, and 116 arranged on a substrate 102. FIG. 1A illustrates ranges of possible placement locations for the six circuit blocks 104, 106, 110, 112, 114, and 116 as broken line boxes surrounding the circuit blocks. For example, the first circuit block 104 could be positioned on the substrate 102 anywhere within the broken line box 118, the second circuit block 106 could be positioned anywhere within the broken line box 120, and so forth. The exact positioning may depend on the amount of space needed for the various standard cells connected to the circuit blocks 104, 106, 110, 112, 114, and 116.

FIG. 1B illustrates a portion of the circuit layout 100 with the third circuit block 110 arranged adjacent to the fifth circuit block 114. The third circuit block 110 includes a first edge 111 that is facing the fifth circuit block 114 and the fifth circuit block 114 includes a second edge 113 facing the third circuit block 114. The third circuit block 110 and the fifth circuit block 114 are arranged on the circuit layout 100 with a gap 150 between the first edge 111 and the second edge 113. A first plurality of standard cells 130 that communicate with the ports on the first edge 111 of the third circuit block 110 are arranged in the gap 150. Similarly, a second plurality of standard cells 140 that communicate with the ports on the second edge 113 of the fifth circuit block 114 are arranged in the gap 150. The third circuit block 110 and the first plurality of standard cells 130 are illustrated in solid line and the fifth circuit block 114 and the second plurality of standard cells 140 are illustrated in broken line. Also, for the purposes of illustration, only a small number of standard cells are shown for each of the circuit blocks 110 and 114. Typically, the circuit blocks 110 and 114 (and the other circuit blocks) would have hundreds, thousands, or millions of standard cells associated with ports on the edges of the circuit blocks. The first plurality of standard cells 130 and the second plurality of standard cells 140 are spaced apart from each other to provide suitable spacing for routing traces between each of the standard cells 130 and 140 and the ports on the respective edges 111 and 113.

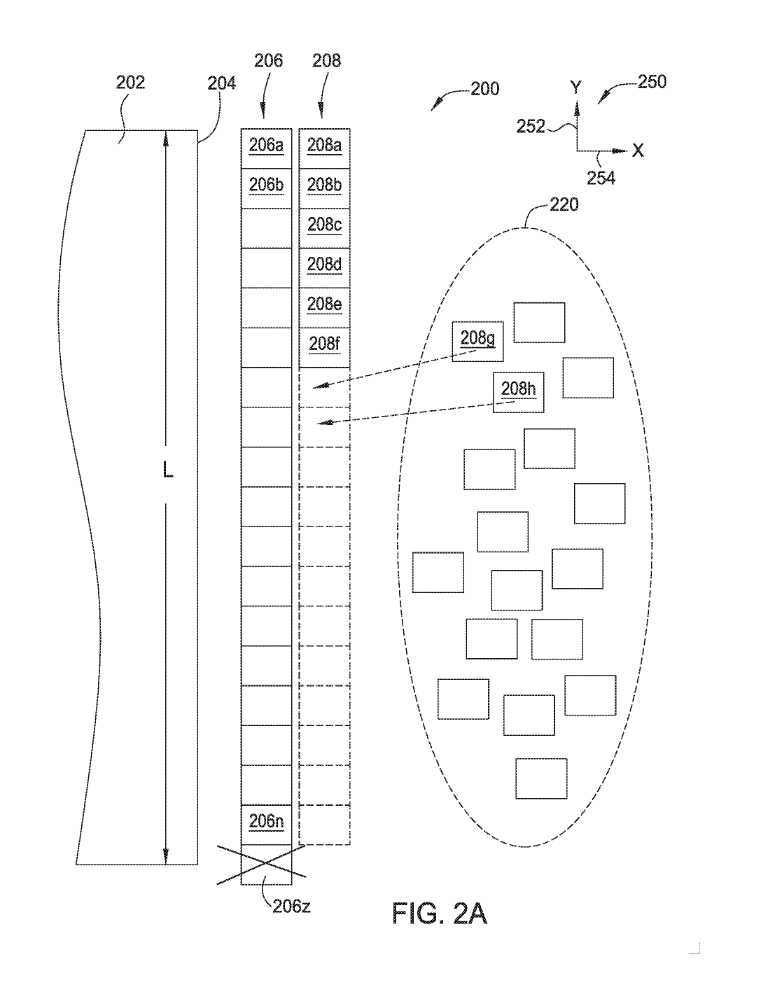

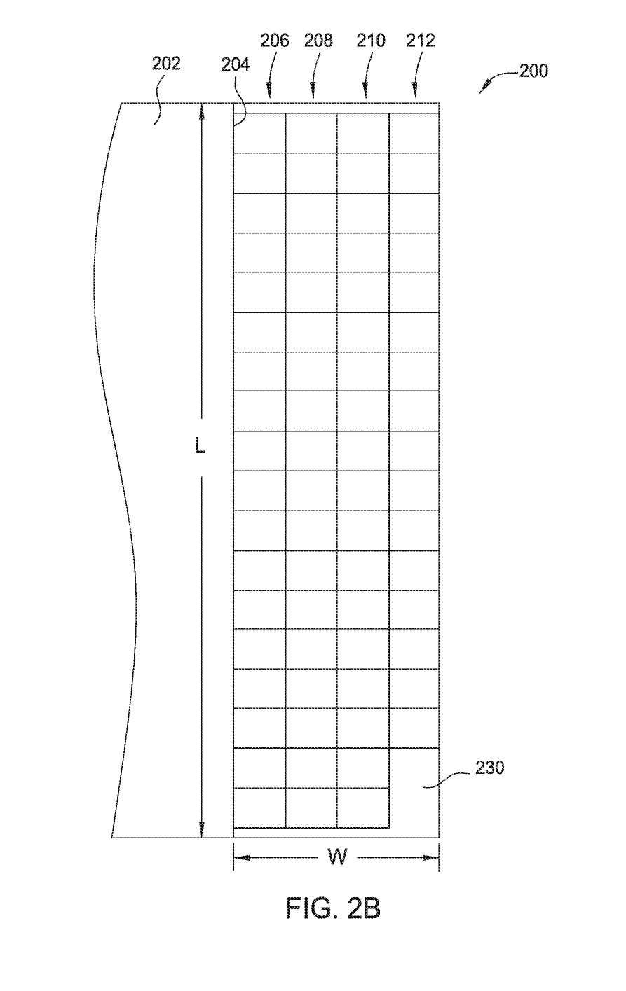

In embodiments described herein, an estimated amount of space from an edge of a circuit block is calculated by determining dimensions of a matrix of the standard cells associated with ports for the edge. The matrix of standard cells includes a dimension away from the edge of the circuit block and that dimension can be used to reserve space along the edge of the circuit block to actually place the standard cells. FIG. 2A illustrates the building of a matrix of standard cells 200 from a pool of standard cells 220 associated with ports along an edge 204 of a circuit block 202. The pool of standard cells 220 could be identified from a data structure that defines connections between ports of the circuit blocks and standard cells. For example, the pool of standard cells 220 could include the various AND gates, OR gates, fillers, and other standard cells to be connected to the ports along the edge 204 of the circuit block 202 or to otherwise be placed along the edge 204 of the circuit block 202. For the purposes of explanation, a coordinate reference 250 with a “y” axis 252 (i.e., a first direction) and an “x” axis 254 (i.e., a second direction) is referenced. The circuit block 202 has a dimension L (i.e., length) along the “y” axis 252. Each of the standard cells has a dimension along the “y” axis and a dimension along the “x” axis 254. The dimensions of the standard cells along the “y” axis 252 can be the same as each other or different from each other. Similarly, the dimensions of the standard cells along the “x” axis can be the same as each other or different from each other. The building of the matrix in FIG. 2A is explained, below, assuming that the standard cells in the pool of standard cells 220 all have the same dimensions along the “x” axis 254 and the “y” axis 252.

To build the matrix, a first calculation is performed to determine the number of standard cells from the pool of standard cells 220 that can be stacked into a column alongside the edge 204 of the circuit block 202. FIG. 2A illustrates a first column 206 with eighteen standard cells 206a, 206b, . . . 206n stacked in the first column 206. As indicated by the “X,” a nineteenth standard cell 206z does not fit within the length L of the edge 204 of the circuit block 202 and therefore cannot fit in the column 206. The number of standard cells that can be stacked in a column is determined by dividing the length L of the edge 204 of the circuit block 202 by a dimension of the standard cells in the pool of standard cells 220 along the “y” axis 252. If the resulting number includes a fraction of a standard cell, then the resulting number should be rounded down to the next integer. For example, FIG. 2A illustrates approximately eighteen and a half standard cells from the pool of standard cells 220 fitting in a column along the length L of the edge 204 of the circuit block 202. A calculation that resulted in eighteen and a half of the standard cells fitting along the edge 204 is rounded down to eighteen.

After the first column 206 of standard cells from the pool of standard cells 220 has been formed, additional columns of standard cells can be formed. For example, FIG. 2A illustrates a second column 208 being formed alongside the first column 206. Six standard cells 208a-208f have been added to the second column 208 and twelve spaces in the second column 208 have not been filled yet (as indicated by the broken lines). A seventh standard cell 208g from the pool of standard cells 220 can be placed in the seventh location in the second column 208 (as indicated by the broken line arrow) and an eighth standard cell 208h from the pool of standard cells 220 can be placed in the eighth location in the second column 208 (as indicated by the broken line arrow), for example. The standard cells from the pool of standard cells 220 are added to columns (and additional columns are added to accommodate the standard cells) until all of the standard cells from the pool of standard cells 220 are arranged in the columns. The matrix 200 is used to estimate the size of the area to reserve for later placement of the pool of standard cells 220. So long as all of the standard cells in the pool of standard cells 220 are added to the matrix 200, the order in which standard cells from the pool of standard cells 220 are added to the matrix 200 does not matter.

FIG. 2B shows the pool of standard cells 220 arranged as the matrix of standard cells 200. In the exemplary scenario depicted in FIG. 2B, there are a total of seventy standard cells arranged in the matrix 200. As discussed above, each full column of the matrix of standard cells 200 includes eighteen standard cells. Thus, the matrix of standard cells 200 includes a full first column 206, a full second column 208, a full third column 210, and a partially-full fourth column 212. The matrix 200 defines an area 230 having the length L of the edge 204 of the circuit block 202 and a width W. The width W of the area 230 is calculated by multiplying the number of columns of standard cells by the dimension of the standard cell along the “x” axis 254. The width W of the area 230 defines the space to be reserved along the edge 204 of the circuit block 202 for eventual placement of standard cells to be associated with ports along the edge 204.

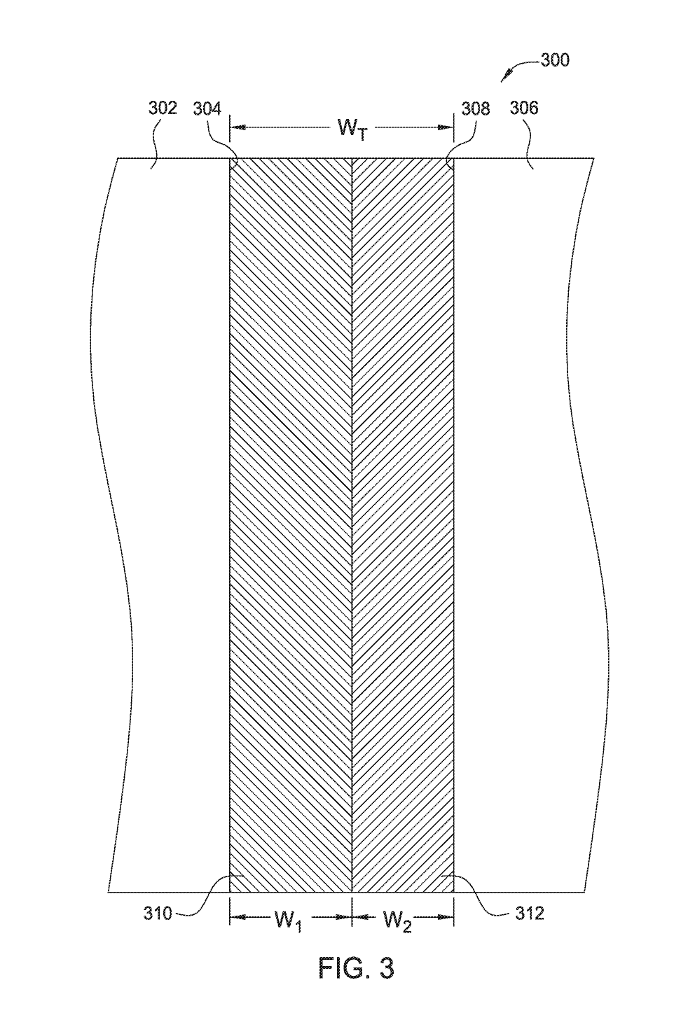

The widths of matrices of standard cells along edges of the various circuit blocks of an electrical circuit layout can be calculated to determine the total spacing required between two adjacent circuit blocks. FIG. 3 illustrates a first circuit block 302 with a first edge 304 and a second circuit block 306 with a second edge 308, wherein the first edge 302 faces the second edge 308 and vice versa. The matrix calculation, discussed above, results in a reserved area 310 for standard cells to be associated with ports on the first edge 304 of the first circuit block 302 and has a first width W₁. The matrix calculation results in a reserved area 312 for standard cells that will be connected to ports on the second edge 308 of the second circuit block 306 and has a second width W₂. Thus, the total width W_{T} between the first edge 304 of the first circuit block 302 and the second edge 308 of the second circuit block 306 is at least equal to the sum of the first width W₁ and the second width W₂. If the first circuit block 302 is the first circuit block to be placed on an electronic circuit layout, then the first circuit block could be located at a first (e.g., arbitrary) location on the layout. Once located, the first circuit block 302 is anchored in place, meaning that its location on the layout is no longer movable. Thereafter, the second circuit block 306 can be located on the electrical circuit layout such that the distance from of a location of the second edge 308 of the second circuit block 306 to the anchored location of the first edge 304 on the first circuit block 302 is at least equal to the total width W_{T}, discussed above. Once the second circuit block 306 is properly located, the second circuit block 306 can be anchored to the electrical circuit layout. Thereafter, placement of additional circuit blocks in the circuit layout can be adjusted and anchored. Additional circuit blocks could be located and anchored to the left of the first circuit block 302, to the right of the second circuit block 306, above the first circuit block 302 and/or the second circuit block 306, and/or below the first circuit block 302 and/or the second circuit block 306. By calculating an estimated amount of space to reserve alongside each edge of the circuit blocks, the circuit blocks can be placed with little or no subsequent iteration of the positions.

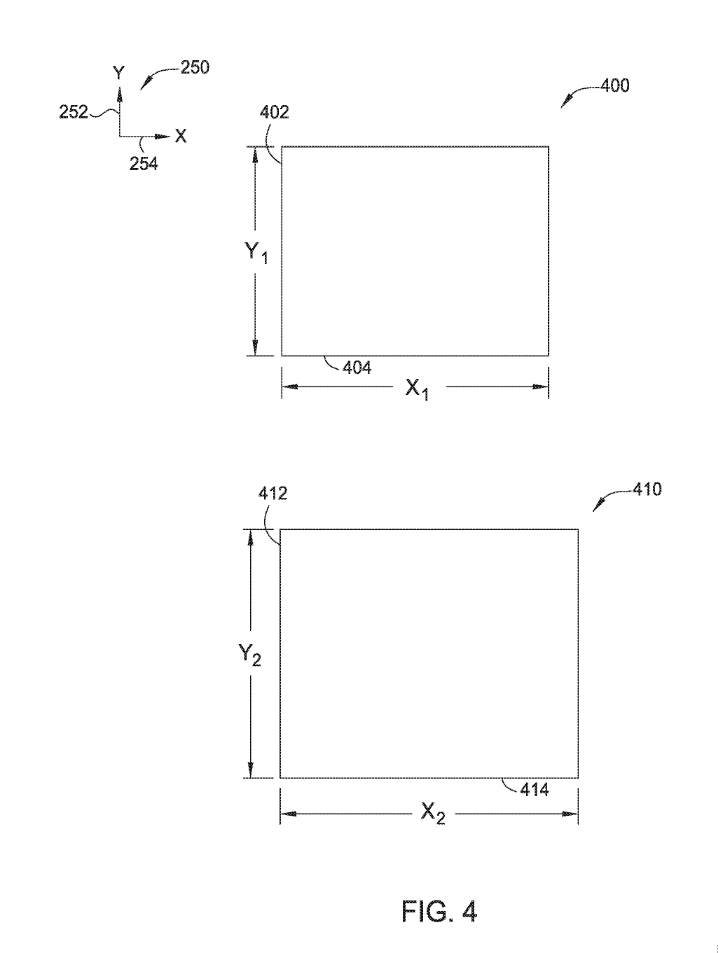

As discussed above, in various circumstances, the standard cells may not all be identical in size. FIG. 4 illustrates dimensions for two different standard cells. A first standard cell 400 includes a dimension y₁ along a first edge 402 along the “y” axis 252 and a dimension x₁ along a second edge 404 along the “x” axis 254. A second standard cell 410 includes a dimension y₂ along a first edge 412 along the “y” axis 252 and a dimension x₂ along a second edge 414 along the “x” axis 254. As depicted in FIG. 4, the dimension y₂ of the first edge 412 of the second standard cell 410 is larger than the dimension y₁ of the first edge 402 of the first standard cell 400. Also, the dimension x₂ of the second edge 414 of the second standard cell 410 is larger than the dimension x₁ of the second edge of the second standard cell 400. Remaining standard cells in a pool of standard cells for an edge of a circuit block could have larger and/or smaller dimensions than the standard cells 400 and 410.

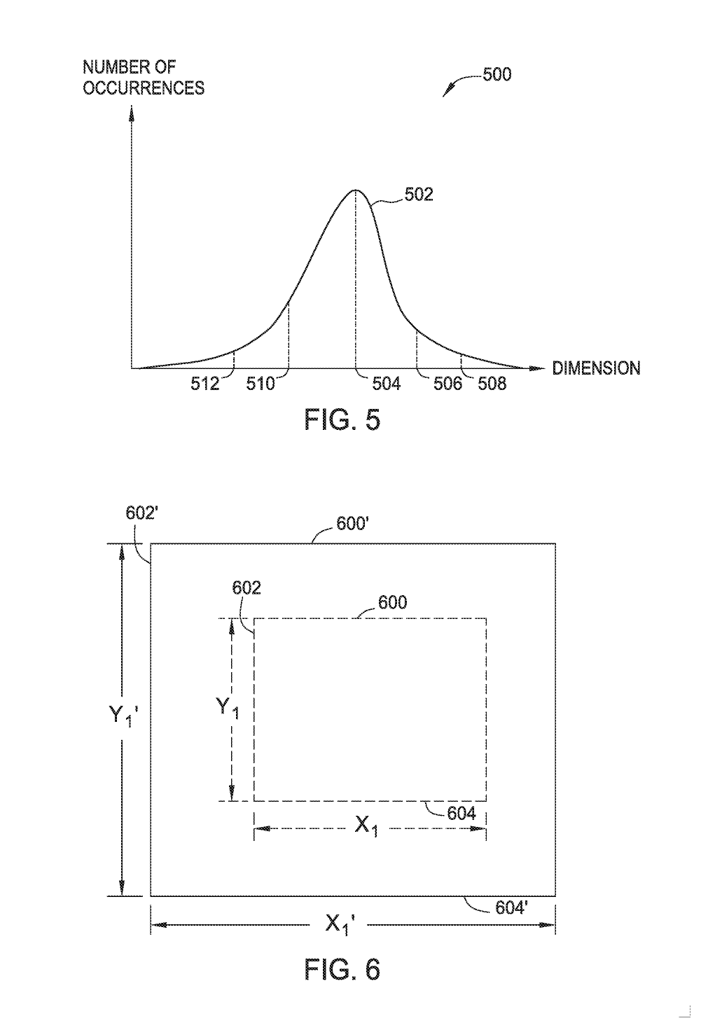

In instances in which hundreds, thousands, or millions of standard cells are to be associated with an edge of a circuit block, it may be impractical to account for the different dimensions of the individual cells when calculating the size of the matrix, discussed above. In such instances, statistically significant dimensions could be used for all of the standard cells in place of the actual dimensions when calculating the size of the matrix. For example, an average dimension (e.g., a mean dimension or a median dimension) of the standard cells along the “x” axis 254 and along the “y” axis 252 could be used in place of the actual dimensions of the standard cells. As another example, a largest dimension along the “x” axis 254 among the pool of standard cells could be used as the dimension along the “x” axis 254 for all of the standard cells. Similarly, a largest dimension along the “y” axis 252 among the pool of standard cells could be used as the dimension along the “y” axis 252 for all of the standard cells. As another example, a dimension equal to a standard deviation from an average dimension could be used. FIG. 5 illustrates an exemplary graph that shows a curve 502 (e.g., a best fit curve) of numbers of occurrences for varying dimension of standard cells (e.g., dimensions along the “x” axis 254 or dimensions along the “y” axis 252). A broken line 504 illustrates an average dimension (e.g., a mean or median dimension) of the standard cells in a pool of standard cells to be associated with an edge of a circuit block. A first set of broken lines 506 and 510 identify dimensions of the standard cells in the pool of standard cells that are one standard deviation larger (broken line 506) and one standard deviation smaller (broken line 510) than the average dimension 504. A second set of broken lines 508 and 512 identify dimensions of the standard cells in the pool that are two standard deviations larger (broken line 508) and two standard deviations smaller (broken line 512) than the average dimension 504. In various embodiments, a dimension equal to the average dimension plus one standard deviation, two standard deviations, or another standard deviation could be used for all of the standard cells in the pool.

Although the matrix-like arrangements shown in FIGS. 2A and 2B do not illustrate any space between the columns and rows of the standard cells, in one embodiment, the standard cells are spaced apart from one another to provide space for placement of routing traces and the like that connect the standard cells to the ports or other standard cells. To account for extra spacing for such routing traces and the like when calculating the area to be reserved along the edges of the circuit blocks, the dimensions of the standard cells along the “x” axis 254 and the “y” axis 252 can be increased, using a utilization factor, for the purposes of calculating the size of the matrix. FIG. 6 illustrates a standard cell (shown in broken line) that has a dimension along a first edge 602 along the “y” axis 252 of y₁ and a dimension along a second edge 604 along the “x” axis 254 of x₁. The dimensions y₁ and x₁ could be the actual dimensions of a particular standard cell or the statistically significant dimensions for a pool of standard cells, discussed above. FIG. 6 illustrates the dimensions for the standard cell used for the purposes of calculating the size of the matrix of a pool of standard cells after a utilization factor has been applied. The standard cell 600′ after the utilization factor has been applied has a dimension along the first edge 602′ along the “y” axis 252 of y₁′, which is larger than the dimension y₁. The standard cell 600′ after the utilization factor has been applied has a dimension along the second edge 604′ along the “x” axis 254 of x₁′, which is larger than the dimension x₁. Referring again to FIGS. 2A and 2B, by increasing the dimensions of the standard cells for the purposes of calculating the size of the matrix, fewer standard cells will fit in a column along an edge of a circuit block, so more columns will likely be needed. Additionally, each of the columns may be wider, thereby increasing the width W of the area (e.g., area 230) of the matrix. Thus, a utilization factor can be used to increase the spacing along the edge of a circuit block to reserve an area for the routing between ports of the circuit block and the standard cells.

In various embodiments, the utilization factor is between 10% and 100%, meaning that the size of a dimension is increased by between 10% and 100%. For example, if a dimension of a side of a standard cell is 1.0 micron and a 10% utilization factor is applied, then the dimension used for the purposes of calculating the size of the matrix of standard cells would be 1.1 microns. If a 100% utilization factor is applied to the 1.0 micron side of the standard cell, then the dimension used for the purposes of calculating the size of the matrix of standard cells would be 2.0 microns. In various embodiments, the utilization factor is between 20% and 90%. In various embodiments, the utilization factor is between 30% and 80%. In various embodiments, the utilization factor is between 30% and 50%.

In various embodiments, a first utilization factor could be applied to the dimension of the standard cells along the “y” axis 252 and a second utilization factor could be applied to the dimension of the standard cells along the “x” axis 254.

In various embodiments, a utilization factor is defined as an area occupied by the standard cells divided by the overall space available. Put differently, the utilization factor=(area occupied by the standard cells/total space available or reserved). In such embodiments, the area 230 of the matrix, calculated above with reference to FIG. 2B, can be calculated. The utilization factor can then be applied to the calculated area to determine the area to be reserved along the edge 204 of the circuit block 202. For example, suppose that a utilization factor of 50% or 0.50 is to be used and the area 230 of the matrix is equal to A. Then, the total space to be reserved for the standard cells is equal to the area 230 of the matrix (A) divided by the utilization ratio (0.5), which is equal to two times A. Referring again to FIG. 2B, since the length L of the matrix of standard cells 200 is fixed, the width W can be doubled to double the area 230 of the matrix.

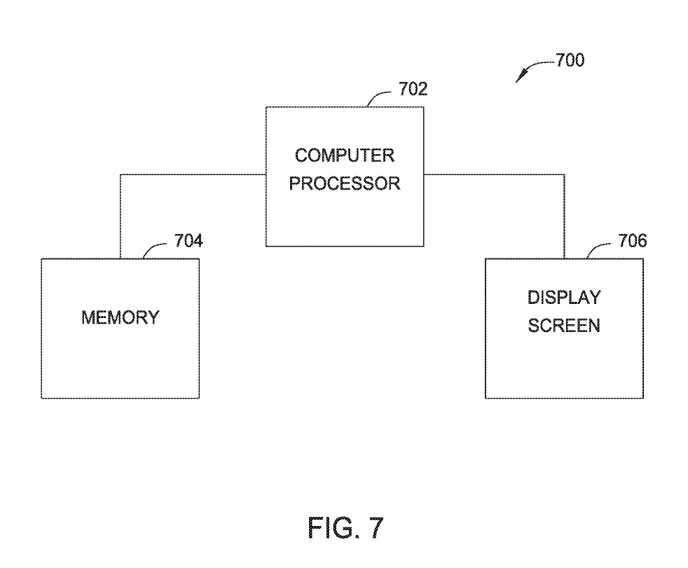

FIG. 7 is a block diagram for a system 700, according to one embodiment, that calculates the sizes of the matrices of standard cells along the edges of circuit blocks for an electrical circuit layout. The system 700 includes a computer processor 702 and computer memory 704 in communication with the computer processor 702. The computer memory 704 can store a computer program, such as computer aided design (CAD) software, that is executable to design or assist an engineer in designing a layout. The computer memory 704 can also store a data structure that defines the various circuit blocks, standard cells, and connections therebetween. The computer memory 704 can store a macro, subroutine, or the like that is executable to identify the number of standard cells that are to be connected to the different edges of the circuit blocks and to calculate the size of a matrices of the standard cells for the different edges. The macro, subroutine, or the like can also place and anchor the circuit blocks (as discussed above) in a CAD model of an electrical circuit layout. The system 700 also includes a display screen 706, such as a liquid crystal display (LCD) or liquid crystal on silicon (LCoS) display. The computer processor 702 can output for display on the display screen 706 the CAD model of the electrical circuit layout. Optionally, the display of the electrical circuit layout could show (e.g., using shaded regions) the areas along the edges of the circuit blocks that are reserved for later placement of the various standard cells.

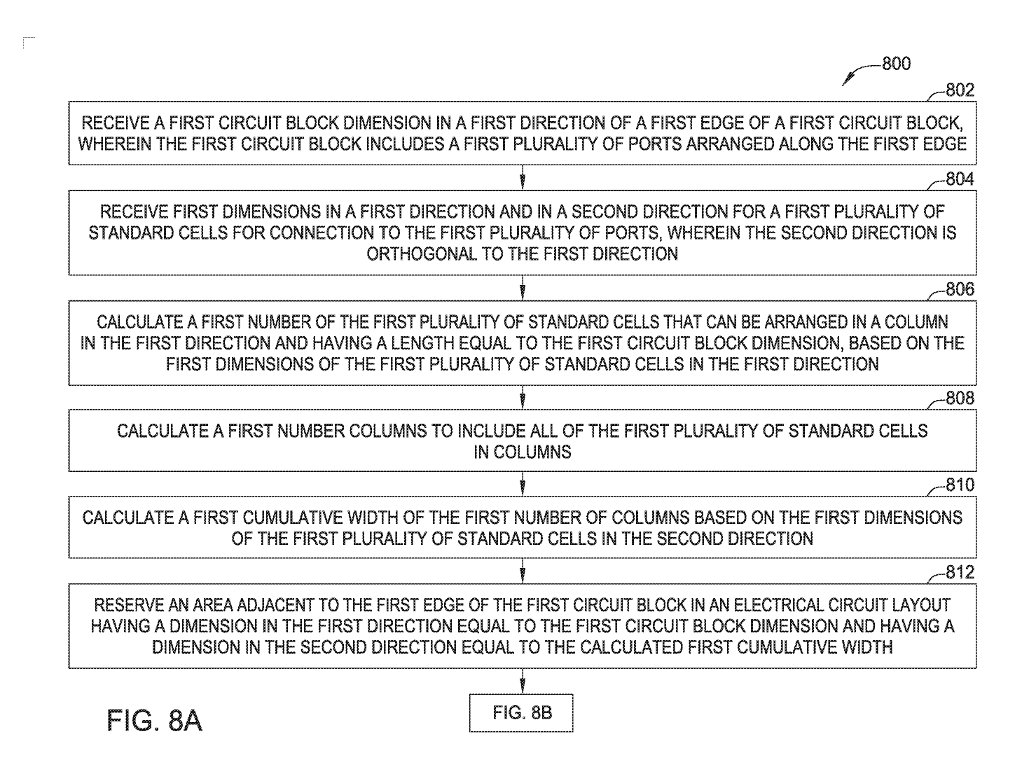

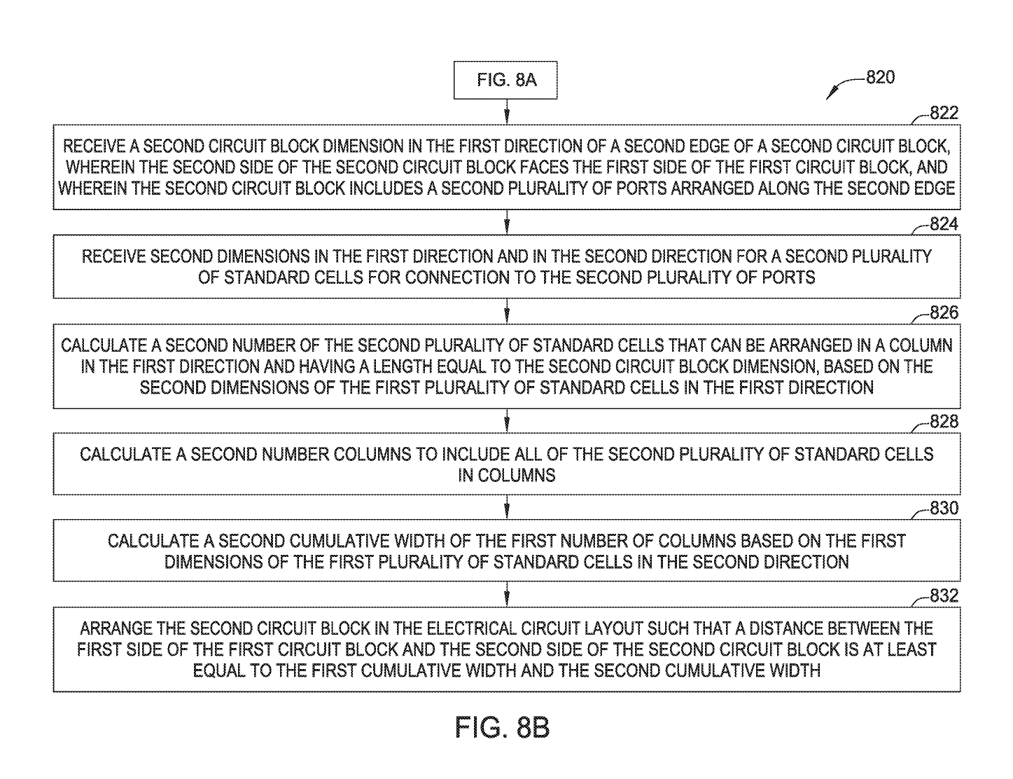

FIG. 8A illustrates a process 800, according to at least one embodiment, for reserving an area along an edge of a circuit block in an electrical circuit layout for standard cells that are in communication with ports of the circuit block on the edge. For example, the process 800 could be implemented by the computer processor 702, discussed above with respect to FIG. 7. In block 802, a dimension of an edge along a first direction of a first circuit block is received. In block 804, dimensions of standard cells to be connected to ports along the edge of the circuit block are received. The dimensions include dimensions along the first direction and along a second direction, which is orthogonal to the first direction. The dimensions could be received from a data structure that defines the various circuit blocks, standard cells, and connections therebetween for the electrical circuit. In block 806, a CAD design tool (e.g., a macro or function executable in CAD software) calculates a number of standard cells that can be arranged in a column along the edge of the circuit block. The column has a length that is equal to or smaller than the received dimension of the edge. As discussed above, the number of standard cells that fits in the column is equal to the length of the column divided by the dimension(s) of the standard cells in the direction along the edge of the circuit block. In the event the resulting number includes a fraction of a standard cell, then the fraction is dropped in at least some embodiments. In block 808, the CAD design tool calculates a total number of columns needed to include all of the standard cells associated with the edge of the circuit block. To do so, the design tool divides the total number of standard cells associated with the edge of the circuit block by the number of standard cells that can be included in each column, calculated above in block 806. In block 810, a cumulative width of the calculated number of columns is determined. The cumulative width of the columns is equal to the product of the number of columns and the dimension(s) of the standard cells along the second direction. In block 812, an area adjacent to the edge of the circuit block is reserved in the electrical circuit layout for eventual placement of the standard cells. The reserved area has a dimension in the first dimension equal to the length of the edge of the circuit block and a dimension in the second dimension equal to the cumulative width of the columns. The process 800 may be repeated for each of the edges of the circuit block. In various embodiments, the circuit block can be anchored to the circuit layout.

In a circuit layout, circuit blocks can be placed close to each other with facing edges close to each other. Each of the facing edges is associated with standard cells that eventually need to be placed in an area along the edge. FIG. 8B is a block diagram for a process 820 for finalizing placement of a second circuit block on the circuit layout relative to the first circuit block, discussed above with respect to FIG. 8A. In block 822, the CAD tool receives a dimension of an edge along the first direction of a second circuit block. In block 824, the CAD tool receives dimensions of standard cells to be connected to ports of the edge or otherwise placed along the edge. The dimensions include dimensions along the first direction and along the second direction. The dimensions could be received from the data structure that defines that various circuit blocks, standard cells, and connections therebetween for the electrical circuit. In block 826, the CAD tool calculates a number of standard cells that can be arranged in a column along the edge of the second circuit block. The column has a length that is equal to or smaller than the received dimension of the edge. As discussed above, the number of standard cells that fits in the column is equal to the length of the column divided by the dimension(s) of the standard cells in the direction along the edge of the second circuit block. In the event the resulting number includes a fraction of a standard cell, then the fraction is dropped in at least some embodiments. In block 828, the CAD tool calculates a total number of columns needed to include all of the standard cells associated with the edge of the second circuit block. The total number of columns needed is calculated by dividing the total number of standard cells associated with the edge of the second circuit block by the number of standard cells that can be included in each column, calculated above in block 826. In block 830, the CAD tool calculates a cumulative width of the calculated number of columns. The cumulative width of the columns is equal to the product of the number of columns and the dimension(s) of the standard cells along the second direction. In block 832, the CAD tool places the second circuit block in the circuit layout in a location such that the distance between the facing edges of the first and second circuit blocks is equal to the cumulative width of the columns associated with the first circuit block (calculated above with reference to FIG. 8A) and the cumulative width of the columns associated with the second circuit block. In various embodiments, the second circuit block can be anchored to the circuit layout after it is placed. Additional circuit blocks can be placed an anchored relative to the first circuit block and/or the second circuit block in a similar manner.

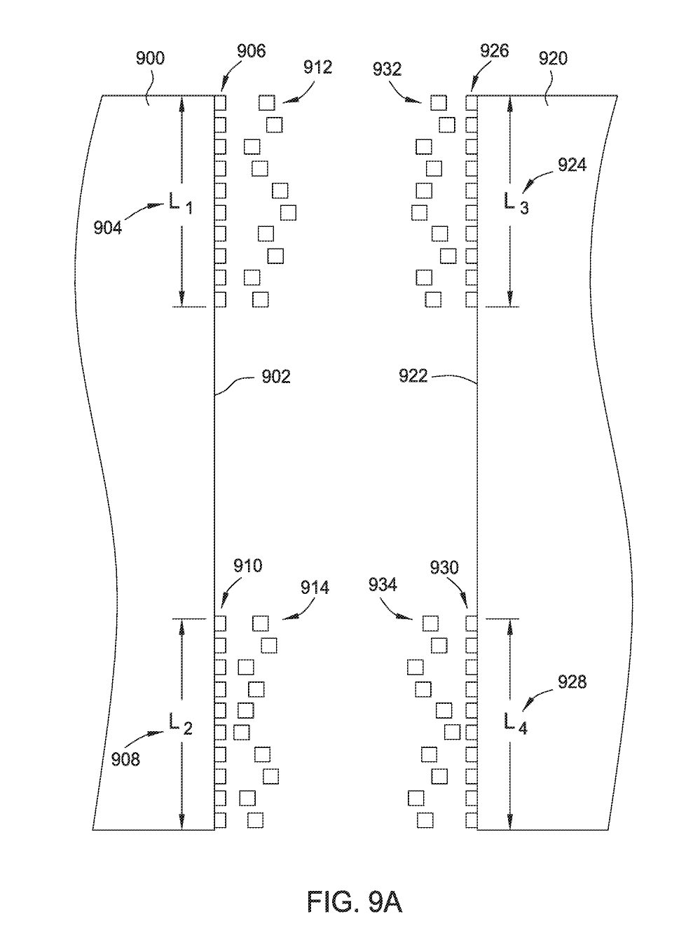

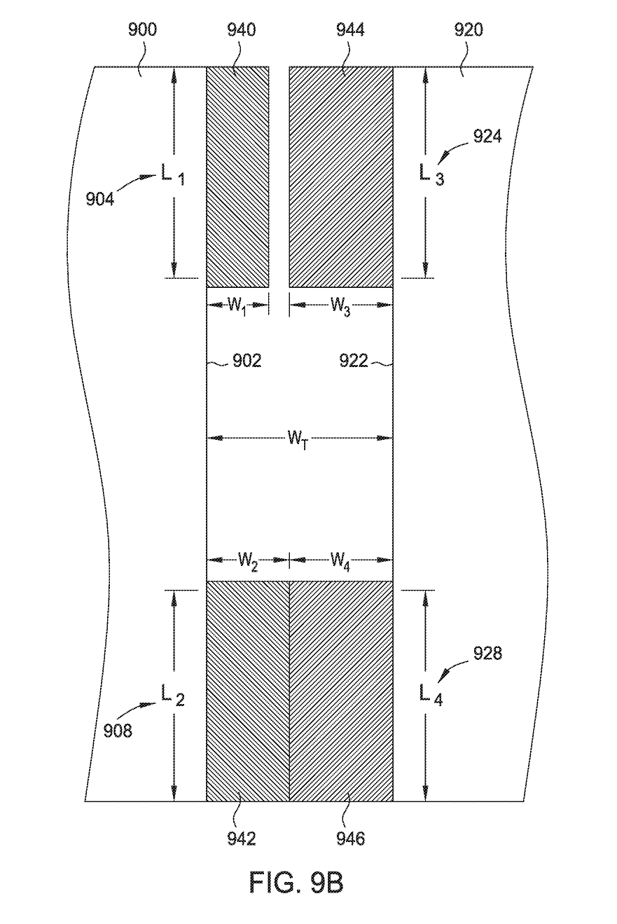

In various embodiments, the ports along an edge of a circuit block may be clustered into particular regions along the edge. FIG. 9A illustrates a first edge 902 of a first circuit block 900 and a second edge 922 of a second circuit block 920. The first edge 902 includes a first region 904 in which a first plurality of ports 906 are arranged. The first edge 902 also includes a second region 908 in which a second plurality of ports 910 are arranged. No ports or only a small number of ports (which would have minimal standard cell placement requirements) are arranged between the first region 904 in the second region 908. The second edge 922 of the second circuit block 920 includes a third region 924 in which a third plurality of ports 926 are arranged. The second edge 922 also includes a fourth region 928 in which a fourth plurality of ports 930 are arranged. No ports or only a small number of ports are arranged between the third region 924 and the fourth region 928. As discussed above, the ports 906, 910, 926, and 928 are very small and the edges 902 and 922 of the circuit blocks 900 and 920 may include hundreds, thousands, or millions of such ports. Here, the ports 906, 910, 926, and 928 are shown enlarged relative to the respective edges 902 and 922, and only a small number of ports 906, 910, 926, and 928 are shown for clarity.

In embodiments in which the ports are clustered into particular regions, the standard cells coupled to these ports may also be clustered into the same regions. For example, a first plurality of standard cells 912 may be clustered proximate to the first region 904. A second plurality of standard cells 914 may be clustered proximate to the second region 908. A third plurality of standard cells 932 may be clustered proximate to the third region 924. And a fourth plurality of standard cells 934 may be clustered proximate to the fourth region 928.

In such circumstances in which the ports are clustered into particular regions along the edge of the circuit block, the dimensions of an area of a matrix of standard cells for each region can be calculated in a manner discussed above. Referring to FIG. 9B, the first region 904 has a length L₁ and a resulting area of a matrix 940 of standard cells to be associated with the ports of the first region 904 has a width of W₁. The second region 908 has a length L₂ and a resulting area of a matrix 942 of standard cells to be coupled to the ports of the first region 908 has a width of W₂. The third region 924 has a length L₃ and a resulting area of a matrix 944 of standard cells to be coupled to the ports of the first region 924 has a width of W₃. The fourth region 928 has a length L₄ and a resulting area of a matrix 946 of standard cells to be coupled to the ports of the first region 928 has a width of W₄.

In FIGS. 9A and 9B, the regions of the first circuit block 900 are at least partially aligned with the regions of the second circuit block 920. For example, the ports 906 of the first region 904 are at least partially aligned with the ports 926 of the third region 924 and the ports 910 of the second region 908 are at least partially aligned with the ports 930 of the fourth region 928. When the regions are partially aligned, the width W_{T} of the gap between the edges 902 and 922 of the circuit blocks 900 and 920 is defined by the widest set of aligned matrices coupled to the regions. For example, FIG. 9B illustrates a first matrix 940 coupled to the first region 904 that has a width W₁, a second matrix 942 coupled to the second region 908 that has a width W₂, a third matrix 944 coupled to the third region 924 that has a width W₃, and a fourth matrix 946 coupled to the fourth region 928 that has a width W₄. In the exemplary scenario shown in FIG. 9B, the sum of the width W₂ of the second matrix 942 and the width W₄ of the fourth matrix 946 is wider than the sum of the width W₁ of the first matrix 940 and the width W₃ of the third matrix 944. Explained visually, boundaries of the second matrix 942 and the fourth matrix 946 are touching when a gap exists between boundaries of the first matrix 940 and the third matrix 944. Thus, the width W_{T} of the gap between the edges 902 and 922 of the circuit blocks 900 and 920 is equal to the sum of the width W₂ of the second matrix 942 and the width W₄ of the fourth matrix 946.

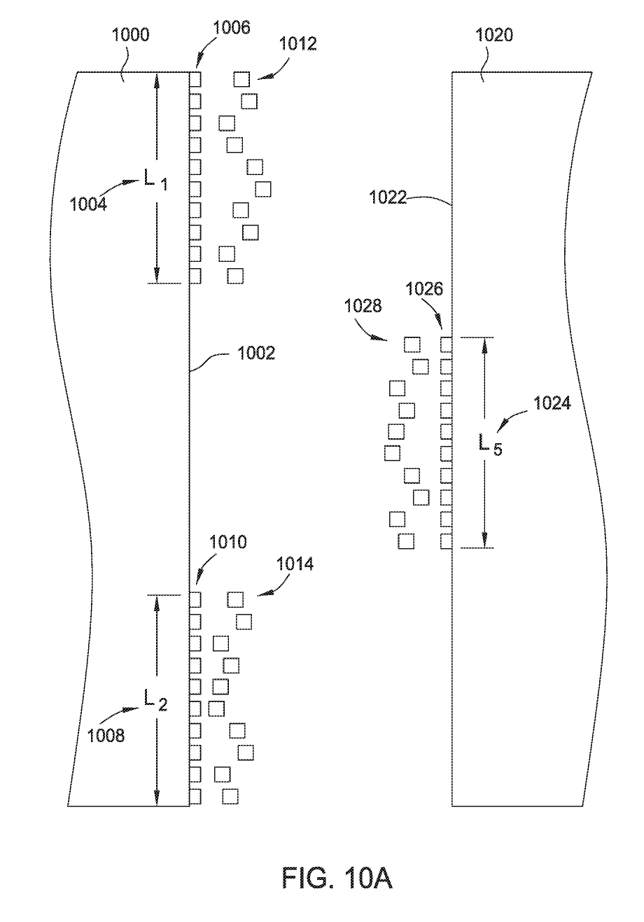

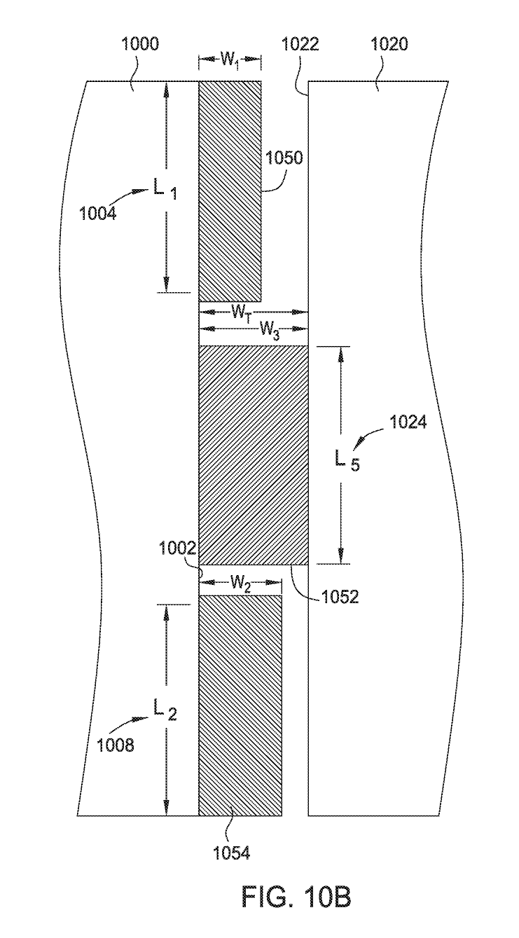

FIG. 10A illustrates a scenario in which a first edge 1002 of a first circuit block 1000 includes a first plurality of ports 1006 in a first region 1004 and a second plurality of ports 1010 in a second region 1008, a second edge 1022 of a second circuit block 1020 includes a third plurality of ports 1026 clustered in a third region 1024, and wherein the first region 1004 and the second region 1008 do not overlap with the third region 1024. A first plurality of standard cells 1012 is coupled to and proximate to the ports 1006 of the first region 1004 and a second plurality of standard cells 1014 is coupled to and proximate to the ports 1010 of the second region 1008. A third plurality of standard cells 1028 is associated with and proximate to the ports 1026 of the third region 1024.

FIG. 10B illustrates the circuit blocks 1000 and 1020 with reserved areas for the standard cells 1012, 1014, 1028, calculated by the matrix sizing operations described above, shown as cross-hatched areas. The first plurality of standard cells 1012 define a matrix having a length L₁ and a width W₁, the second plurality of standard cells 1014 define a matrix having a length L₂ and a width W₂, and the third plurality of standard cells 1028 define a matrix having a length L₃ and a width W₃. In the exemplary scenario depicted in FIGS. 10A and 10B in which the clusters of ports in standard cells do not overlap, the reserved area having the largest width defines the distance W_{T} between the first edge 1002 of the first circuit block 1000 and the second edge 1022 of the second circuit block 1020. In the exemplary scenario, the reserved area 1052 for the third plurality of standard cells 1028 has the largest width (width W₃) and therefore defines the width W_{T} between the first edge 1002 and the second edge 1022.

Defining the reserved areas surrounding circuit blocks by calculating sizes of matrices of standard cells associated with sides of the circuit blocks could be computationally intensive for large numbers of circuit blocks on an electrical circuit layout. In some instances, certain calculations may not be necessary if two circuit blocks will be separated by a sufficient distance in the layout. In various embodiments, a threshold distance between circuit blocks could be used to determine whether the above described matrix sizing operations need to be performed for a particular circuit block or for two adjacent circuit blocks. For example, with reference to FIG. 1A, the fourth circuit block 112 and the sixth circuit block 116 are spaced apart by a minimum distance “d,” based on the possible positioning indicated by broken line boxes 124 and 128. By contrast, the second circuit block 106 and the fourth circuit block 112 are spaced apart by a minimum distance “D,” based on the possible positioning indicated by broken line boxes 120 and 124. The distance “D” is larger than the distance “d.” In one exemplary circumstance, the distance “d” could be less than the threshold distance and the distance “D” could be greater than the threshold distance. In such a circumstance, the matrix sizing operations, described above would be performed for the facing edges of the circuit blocks 112 and 116, but would not be performed facing edges of the circuit blocks 106 and 112.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement embodiments of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., applications for calculating the size of a matrix of standard cells along an edge of a circuit block) or related data available in the cloud. For example, the matrix size calculation application could execute on a computing system in the cloud and calculate the sizes of areas of matrices of standard cells along the edges of circuit blocks. In such a case, the matrix size calculation application could calculate the sizes of the matrices and the resulting dimensions from the edges of the circuit blocks to be reserved and store the resulting dimensions at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A computer-implemented method for planning a layout of an electrical circuit, the method comprising:
receiving a first circuit block dimension in a first direction of a first side of a first circuit block, wherein the first circuit block includes a first plurality of ports arranged along the first side;
receiving first dimensions in the first direction and in a second direction for a first plurality of standard cells for connection to the first plurality of ports, wherein the second direction is orthogonal to the first direction;
calculating a first number of the first plurality of standard cells that can be arranged in a column along the first direction and having a length equal to or less than the first circuit block dimension based on the first dimensions of the first plurality of standard cells in the first direction;
calculating a first number of columns to include all of the first plurality of standard cells in columns based on the first number of the standard cells that can be arranged in each column;
calculating a first cumulative width of the first number of columns based on the first dimensions of the first plurality of standard cells in the second direction; and
reserving an area adjacent to the first side of the first circuit block in an electrical circuit layout having a dimension in the first direction equal to the first circuit block dimension and having a dimension in the second direction equal to the calculated first cumulative width.

2. The computer-implemented method of claim 1, further comprising:
receiving a second circuit block dimension in the first direction of a second side of a second circuit block, wherein the second side of the second circuit block faces the first side of the first circuit block, and wherein the second circuit block includes a second plurality of ports arranged along the second side;
receiving second dimensions in the first direction and in the second direction for a second plurality of standard cells for connection to the second plurality of ports;
calculating a second number of the second plurality of standard cells that can be arranged in a column in the first direction and having a length equal to the second circuit block dimension, based on the second dimensions of the first plurality of standard cells in the first direction;
calculating a second number of columns to include all of the second plurality of standard cells in columns;
calculating a second cumulative width of the first number of columns based on the first dimensions of the first plurality of standard cells in the second direction; and
arranging the second circuit block in the electrical circuit layout such that a distance between the first side of the first circuit block and the second side of the second circuit block is at least equal to the first cumulative width and the second cumulative width.

3. The computer-implemented method of claim 2, further comprising anchoring the location of the first circuit block in the electrical circuit layout, and wherein the second circuit block is arranged relative to the first circuit block.

4. The computer-implemented method of claim 1, further comprising:
modifying the first dimensions of the first plurality of standard cells by multiplying the first dimensions in the first direction and in the second orthogonal direction by a utilization factor;
wherein calculating the first number of the first plurality of standard cells that can be arranged in a column in the first direction and having a length equal to the first circuit block dimension comprises calculating the first number based on the modified first dimensions of the first plurality of standard cells in the first direction; and
wherein calculating the first cumulative width of the first number of columns based on the first dimensions of the first plurality of standard cells in the second direction comprises calculating the first cumulative width based on the modified second dimensions of the first plurality of standard cells in the second direction.

5. The computer-implemented method of claim 1, wherein calculating the first number of the first plurality of standard cells that can be arranged in a column in the first direction and having a length equal to the first circuit block dimension comprises calculating a first statistically significant dimension for the first plurality of standard cells in the first direction and calculating the first number based on the first statistically significant dimension.

6. The computer-implemented method of claim 6, wherein the first statistically significant dimension is selected from the group consisting of:
a mean of the first dimensions in the first direction;
a median of the first dimensions in the first direction;
a largest dimension of the first dimensions in the first direction; and
a dimension that is a standard deviation above an average of the first dimensions in the first direction.

7. The computer-implemented method of claim 1, wherein calculating a first cumulative width of the first number of columns based on the first dimensions of the first plurality of standard cells in the second direction comprises calculating a second statistically significant dimension for the first plurality of standard cells in the second direction and calculating the first cumulative width based on the second statistically significant dimension.

8. The computer-implemented method of claim 7, wherein the second statistically significant dimension is selected from the group consisting of:
a mean of the first dimensions in the second direction;
a median of the first dimensions in the second direction;
a largest dimension of the first dimensions in the second direction; and
a dimension that is a standard deviation above an average of the first dimensions in the second direction.

9. A computer program product for planning a layout of an electrical circuit, the computer program product comprising:
a computer-readable storage medium having computer-readable program code embodied therewith, the computer-readable program code executable by one or more computer processors to:
receive a first circuit block dimension in a first direction of a first side of a first circuit block, wherein the first circuit block includes a first plurality of ports arranged along the first side;
receive first dimensions in the first direction and in a second direction for a first plurality of standard cells for connection to the first plurality of ports, wherein the second direction is orthogonal to the first direction;
calculate a first number of the first plurality of standard cells that can be arranged in a column along the first direction and having a length equal to the first circuit block dimension, based on the first dimensions of the first plurality of standard cells in the first direction;
calculate a first number of columns to include all of the first plurality of standard cells in columns;
calculate a first cumulative width of the first number of columns based on the first dimensions of the first plurality of standard cells in the second direction; and
reserve an area adjacent to the first side of the first circuit block in an electrical circuit layout having a dimension in the first direction equal to the first circuit block dimension and having a dimension in the second direction equal to the calculated first cumulative width.

10. The computer program product of claim 9, wherein the computer-readable program code is further executable to:
receive a second circuit block dimension in the first direction of a second side of a second circuit block, wherein the second side of the second circuit block faces the first side of the first circuit block, and wherein the second circuit block includes a second plurality of ports arranged along the second side;
receive second dimensions in the first direction and in the second direction for a second plurality of standard cells for connection to the second plurality of ports;
calculate a second number of the second plurality of standard cells that can be arranged in a column in the first direction and having a length equal to the second circuit block dimension, based on the second dimensions of the first plurality of standard cells in the first direction;
calculate a second number of columns to include all of the second plurality of standard cells in columns;
calculate a second cumulative width of the first number of columns based on the first dimensions of the first plurality of standard cells in the second direction; and
arrange the second circuit block in the electrical circuit layout such that a distance between the first side of the first circuit block and the second side of the second circuit block is at least equal to the first cumulative width and the second cumulative width.

11. The computer program product of claim 10, wherein the computer-readable program code is further executable to anchor the location of the first circuit block in the electrical circuit layout, and wherein the second circuit block is arranged relative to the first circuit block.

12. The computer program product of claim 9, wherein a utilization factor is defined as an area occupied by the first plurality of standard cells divided by the total area reserved for the first plurality of standard cells, wherein the utilization factor is predetermined, and wherein the area reserved adjacent to the first side of the first circuit block has a dimension in the second direction has a dimension equal to cumulative width divided by the utilization factor.

13. The computer program product of claim 9, wherein calculating the first number of the first plurality of standard cells that can be arranged in a column in the first direction and having a length equal to the first circuit block dimension comprises calculating a first statistically significant dimension for the first plurality of standard cells in the first direction and calculating the first number based on the first statistically significant dimension.

14. The computer program product of claim 9, wherein calculating a first cumulative width of the first number of columns based on the first dimensions of the first plurality of standard cells in the second direction comprises calculating a second statistically significant dimension for the first plurality of standard cells in the second direction and calculating the first cumulative width based on the second statistically significant dimension.

15. A system for planning a layout of an electrical circuit, the system comprising:
a computer processor; and
a computer memory containing a program that, when executed on the computer processor, performs an operation for processing data, comprising:
receiving a first circuit block dimension in a first direction of a first side of the first circuit block, wherein the first circuit block includes a first plurality of ports arranged along the first side;
receiving first dimensions in the first direction and in a second direction for a first plurality of standard cells for connection to the first plurality of ports, wherein the second direction is orthogonal to the first direction;
calculating a first number of the first plurality of standard cells that can be arranged in a column along the first direction and having a length equal to the first circuit block dimension, based on the first dimensions of the first plurality of standard cells in the first direction;
calculating a first number of columns to include all of the first plurality of standard cells in columns;
calculating a first cumulative width of the first number of columns based on the first dimensions of the first plurality of standard cells in the second direction; and
reserving an area adjacent to the first side of the first circuit block in an electrical circuit layout having a dimension in the first direction equal to the first circuit block dimension and having a dimension in the second direction equal to the calculated first cumulative width.

16. The system of claim 15, wherein the program performs an additional operation for processing data, comprising:
receiving a second circuit block dimension in the first direction of a second side of a second circuit block of the plurality of circuit blocks, wherein the second side of the second circuit block faces the first side of the first circuit block, and wherein the second circuit block includes a second plurality of ports arranged along the second side;
receiving second dimensions in the first direction and in the second direction for a second plurality of standard cells for connection to the second plurality of ports;
calculating a second number of the second plurality of standard cells that can be arranged in a column in the first direction and having a length equal to the second circuit block dimension, based on the second dimensions of the first plurality of standard cells in the first direction;
calculating a second number of columns to include all of the second plurality of standard cells in columns;
calculating a second cumulative width of the first number of columns based on the first dimensions of the first plurality of standard cells in the second direction; and
arranging the second circuit block in the electrical circuit layout such that a distance between the first side of the first circuit block and the second side of the second circuit block is at least equal to the first cumulative width and the second cumulative width.

17. The system of claim 16, wherein program calculates a cumulative width for a third circuit block of the plurality of circuit blocks and arranges the third circuit block relative to at least one of the first circuit block and the second block if an approximate location of the third circuit block is within a threshold distance of an approximate location for the first circuit block or an approximate location for the second circuit block; and
wherein the program ignores a fourth circuit block of the plurality of circuit blocks if an approximate location of the fourth circuit block is outside of the threshold distance of the approximate location for the first circuit block, the approximate location for the second circuit block or the approximate location for the third circuit block.

18. The system of claim 15, wherein the program performs an additional operation for processing data, comprising:
modifying the first dimensions of the first plurality of standard cells by multiplying the first dimensions in the first direction and in the second orthogonal direction by a utilization factor;
wherein calculating the first number of the first plurality of standard cells that can be arranged in a column in the first direction and having a length equal to the first circuit block dimension comprises calculating the first number based on the modified first dimensions of the first plurality of standard cells in the first direction; and
wherein calculating the first cumulative width of the first number of columns based on the first dimensions of the first plurality of standard cells in the second direction comprises calculating the first cumulative width based on the modified second dimensions of the first plurality of standard cells in the second direction.

19. The system of claim 15, wherein calculating the first number of the first plurality of standard cells that can be arranged in a column in the first direction and having a length equal to the first circuit block dimension comprises calculating a first statistically significant dimension for the first plurality of standard cells in the first direction and calculating the first number based on the first statistically significant dimension.

20. The system of claim 19, wherein calculating a first cumulative width of the first number of columns based on the first dimensions of the first plurality of standard cells in the second direction comprises calculating a second statistically significant dimension for the first plurality of standard cells in the second direction and calculating the first cumulative width based on the second statistically significant dimension.
